(19) United States
(12) Patent Application Publication
(10) Pub. No.: US 2019/0023994 A1
(43) Pub. Date: Jan. 24, 2019

(54) REMOVAL OF MERCURY BY CHEMICAL ADDITION AND MECHANICAL SEPERATION

(71) Applicant: Chevron U.S.A. Inc., San Ramon, CA (US)

(72) Inventors: Evan Shigeto Hatakeyama, Richmond, CA (US); Kyle Kozo Higashidani, Walnut Creek, CA (US); Francisco Lopez-Linares, Richmond, CA (US); Michelle Marie Hart, Richmond, CA (US)

(21) Appl. No.: 16/038,719

(22) Filed: Jul. 18, 2018

Related U.S. Application Data
(60) Provisional application No. 62/533,966, filed on Jul. 18, 2017.

(51) Int. Cl. C10G 29/10; C10G 29/20; C10G 31/08; C10G 31/10; B01D 53/14

(52) U.S. Cl. CPC C10G 29/10; C10G 29/20; C10G 2300/80; C10G 31/10; B01D 53/14; C10G 31/08

(57) ABSTRACT

A process for the removal of mercury comprising reacting a sulfide source with HgS solids to increase the size and sedimentation rate of the submicron mercury for removal by filtration or other mechanical processes is described herein.

An embodiment of the invention is the use of monothiols to react with mercury to form dissolved mercury, wherein silica with immobilized thiol groups is added to the dissolved mercury, allowing for removal with a coarse filter.

### BACKGROUND OF THE INVENTION

Natural gas and crude oils produced in certain geographic areas of the world contain mercury in sufficient quantities to make them undesirable as refinery or petrochemical plant feedstocks. Condensates and crude oils derived from natural gas and crude oil production worldwide may contain over 1000 parts per billion by weight (ppbw) of mercury. If these condensates and crudes are distilled without first removing the mercury, it will pass into distillate hydrocarbon streams, such as naphtha and gas oils, derived from these feeds and poison hydrotreating and other catalysts used to further refine these distillate streams.

In the past, adsorbents, gas stripping and chemical precipitation methods have been used to remove mercury from crudes and other hydrocarbon liquids prior to their processing in order to avoid catalyst poisoning problems. The use of fixed bed adsorbents, such as activated carbon, molecular sieves, metal oxide-based adsorbents and activated alumina, to remove the mercury is a potentially simple approach but has several disadvantages. For example, solids in the crude oil tend to plug the adsorbent bed, and the cost of the adsorbent may be excessive when mercury levels are greater than 100 to 300 ppbw. Also, large quantities of spent adsorbent are produced when treating hydrocarbon liquids having high levels of mercury, thereby making it imperative to process the spent adsorbent to remove adsorbed mercury before either recycle or disposal of the adsorbent.

Gas stripping, although simple, also has drawbacks. To be effective the stripping must be conducted at high temperature with relatively large amounts of stripping gas. Since crudes contain a substantial amount of light hydrocarbons that are stripped with the mercury, these hydrocarbons must be condensed and recovered to avoid substantial product loss. Moreover, the stripping gas must either be disposed of or recycled, both of which options require the stripped mercury to be removed from the stripping gas.

Chemical precipitation includes the use of hydrogen sulfide or sodium sulfide to convert mercury in the liquid hydrocarbons into solid mercury sulfide, which is then separated from the hydrocarbon liquids. As taught in the prior art, this method requires large volumes of aqueous sodium sulfide solutions to be mixed with the liquid hydrocarbons. The drawbacks of this requirement include the necessity to maintain large volumes of two liquid phases in an agitated state to promote contact between the aqueous sodium sulfide solution and the hydrocarbon liquids, which in turn can lead to the formation of an oil-water emulsion that is difficult to separate.

Processes to efficiently remove relatively large quantities of mercury from crude oils and other liquid hydrocarbons without the disadvantages of conventional techniques is therefore desired.

### SUMMARY OF THE INVENTION

A process for the removal of mercury comprising reacting a sulfide source with HgS solids to increase the size and sedimentation rate of the submicron mercury for removal by filtration or other mechanical processes is described herein.

An embodiment of the invention is the use of monothiols to react with mercury to form dissolved mercury, wherein silica with immobilized thiol groups is added to the dissolved mercury, allowing for removal with a coarse filter.

### BRIEF DESCRIPTION OF THE DRAWINGS

FIG. 1 is a drawing of multiple mercury feed streams depicting high mercury feed input and low mercury product output.

FIG. 2 is a graph of mercury concentration in the filtrate (y-axis) vs Na2S concentrate in sample G (x-axis, log scale). The condensate blend had an initial mercury concentration of 1,300 ppb. Various concentrations of Na2S in the condensate were achieved by adding different concentrations of Na2S in water at fixed dosages. After addition of Na2S, the solution was mixed and allowed to react for 60 mins. It was then filtered through a 0.45 micron PTFE filter. Mercury measurement was determined by Lumex.

FIG. 3 is a graph of mercury concentrate in filtrate (y-axis) vs filter size (x-axis, log scale). The condensate blend had an initial mercury concentration of 1,300 ppb. 400 ppb of Na2S in the condensate were achieved by adding 2 wt-% Na2S in water. After addition of Na2S, the solution was mixed and allowed to react for 60 mins. It was then filtered through a 0.1, 0.2, 0.45, 1, 5, and 20 micron PTFE filter. The data point at 50 micron is the unfiltered mercury concentration. Mercury measurement was determined by Lumex.

FIG. 4 is a plot of HT-CG-ICP-MS data showing Hg intensity (y-axis) vs boiling point (x-axis) of condensate samples. Data shows that mercury in samples is volatilized above 550° F. This suggests mercury removed by Na2S addition is not elemental but more likely HgS based.

FIG. 5 is a bar graph of mercury concentrate (y-axis, log scale) of sample G condensate (well 3B 1.050) after 1.5 hrs of settling (blue) or filtration by a 0.45 micron filter (green) with the addition of an additive (x-axis). The sample G condensate had an initial mercury concentration of 1,100 ppb. Approximately 2 wt-% of additive was allowed to react with the sample G condensate for 60 mins before settling and filtration.

FIG. 6 is a graph of mercury concentration (y-axis) of sample G condensate (well 3b 1.050) after overnight settling (blue) or filtration by 0.45 micron filter (green) with the addition of different concentrations of thiol SAMMS (x-axis, log scale). The sample G condensate had an initial mercury concentration of 1,100 pbb. The 10 ppm additive concentration point is the removal without additive. The thiol SAMMS was allowed to reactor for 60 mins before settling and filtration.

FIG. 7 is a plot of mercury concentrate (y-axis) of sample E condensate after 1.5 hrs of settling (blue) or filtration by a 0.45 micron filter (green) with the addition of an additive (x-axis). The sample E condensate had an initial mercury concentration of 2,400 ppb. Approximately 2 wt-% of additive was allowed to react with the sample E condensate for 60 mins before settling and filtration.

FIG. 8 is a plot of mercury concentration (y-axis) of sample E condensate after 1.5 hr settling, overnight settling, or filtration by 0.45 micron filter with the addition of different concentrations of thiol SAMMS (x-axis, log scale). The sample E condensate had an initial mercury concentration of 2,400 pbb. The 10 ppm additive concentration point is the removal without additive. The thiol SAMMS was allowed to reactor for 60 mins before settling and filtration.

FIG. 9 is a plot of mercury concentrate (y-axis) of CVX crude filtration by a 0.45 micron filter (green) with the addition of an additive (x-axis). The CVX crude had an initial mercury concentration of 9,000 ppb. Approximately 2 wt-% of additive was allowed to react with the crude for 60 mins before settling and filtration.

FIG. 10 is a plot of the mercury concentration of CVX crude after filtration with 0.2, 0.45, 1, 5, 10, and 20 micron filters. The CVX crude had an initial mercury concentration of 9,000 ppb. Approximately 2 wt-% of additive (sodium sulfide and thiol SAMMS separately) added to CVX crude.

FIG. 11 is a graph of the mercury concentration of CVX crude after filtration with 0.45 micron filter. The CVX crude had an initial mercury concentration of 9,000 ppb. Approximately 2 wt-% of additive (hexanethiol, ethanedithiol, and hexanethiol+thiol SAMMS, separately) were added to CVX crude.

FIG. 12 is a graph of the effect of chemical additives (2 ppm Na2S and 300 ppm thiol solid) on mercury removal. Additives were allowed to react with mixing for 1 hr before experiment. This data is based on samples withdrawn from a 30 cm sedimentation height.

FIG. 13 is a graph of mercury removal from condensate blend by centrifugation with additives. Centrifuge operating at 1600 rpm or 360 g-force. Na2S was dosed in as a 2 wt-% aqueous solution. Additives were mixed for 1 hr before centrifugation studies. Both additives increased removal and decreased separation time.

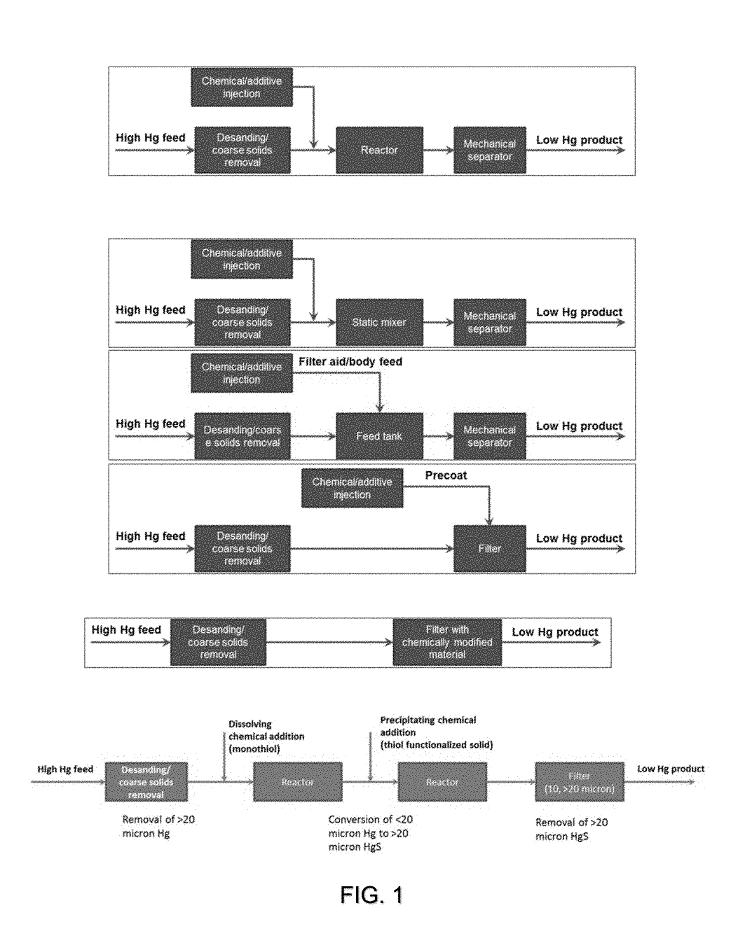

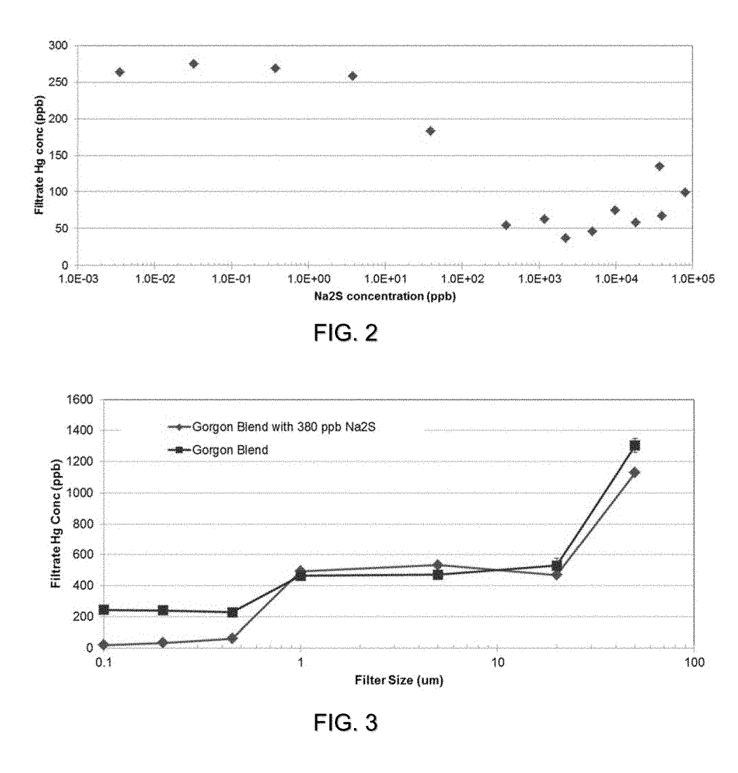

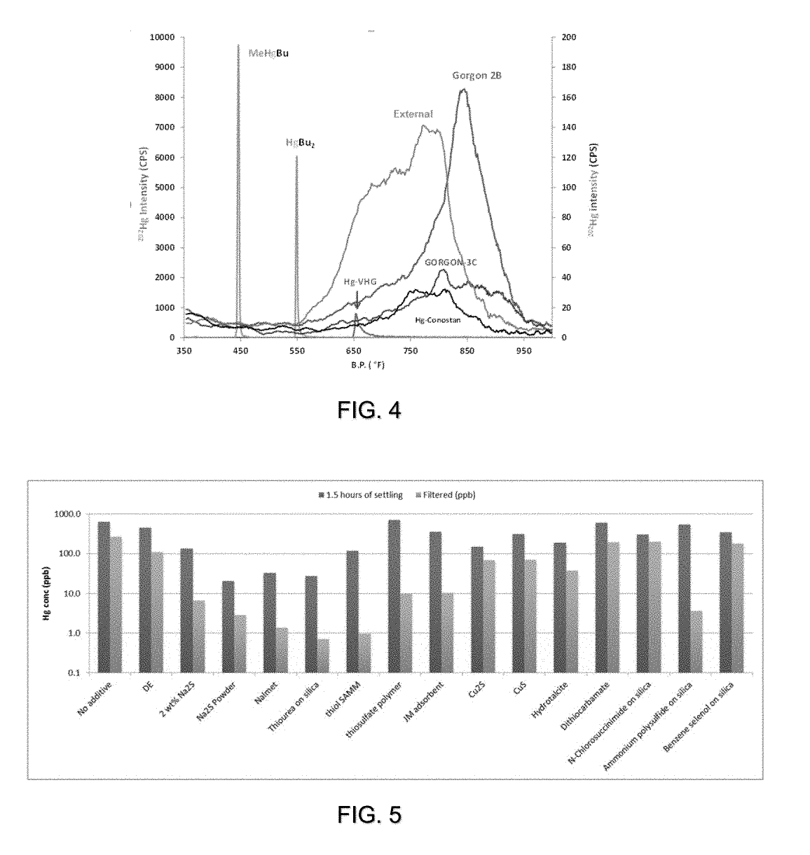

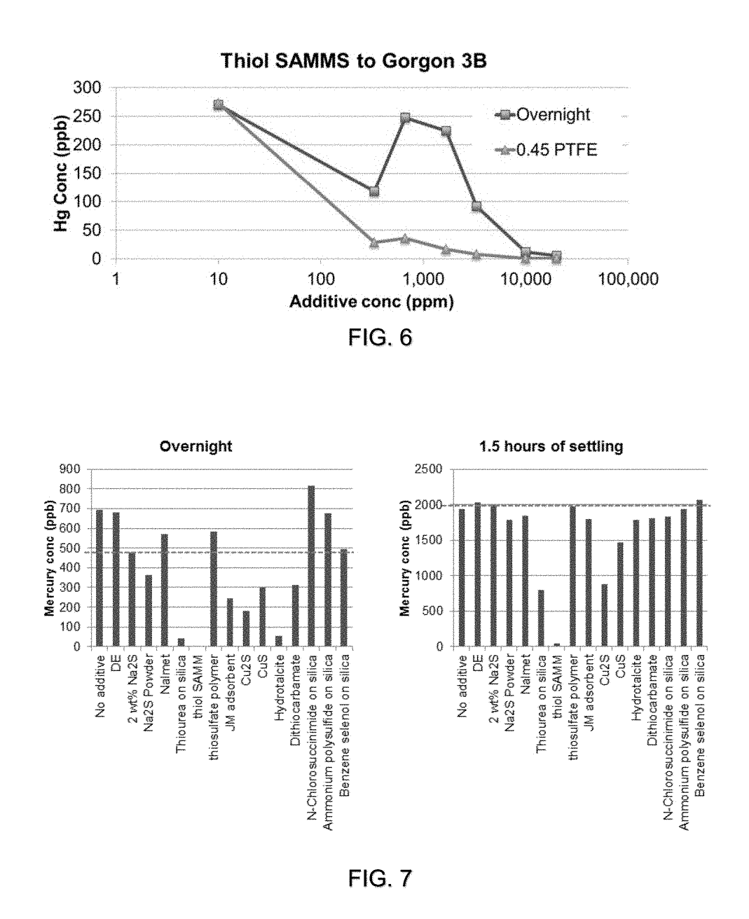

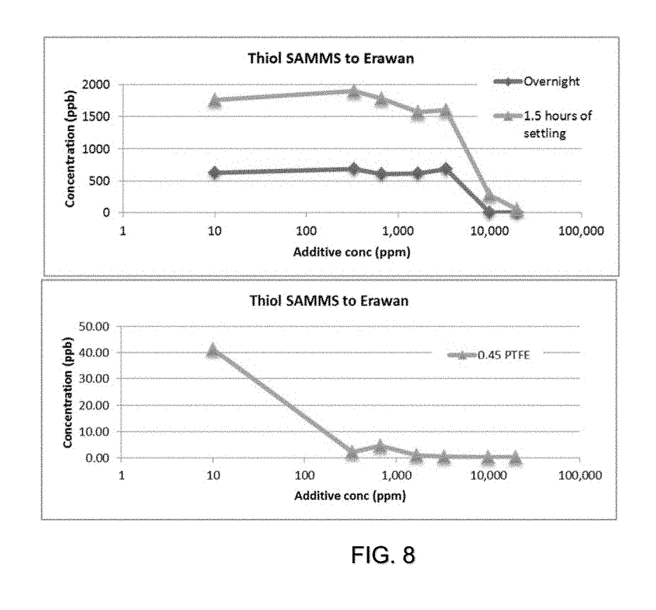

### DETAILED DESCRIPTION

“Dissolved Mercury” for the purpose of the description below, dissolved mercury is any mercury that can pass through a 0.45 micron filter. This includes Hg, any form of Hg2+, or any <0.45 micron Hg solid such as HgS.

“Coarse filter” constitutes a filtration of particles greater than 5 microns, preferably greater than 20 microns.

An embodiment of the invention is a process for the removal of mercury by the addition of a solid sulfide source, such as Na2S that can be dissolved in polar solvents such as water, methanol, ethanol, glycols, and other liquid sulfide sources including polymers, or solids —CuS, thiols/sulfide/other S immobilized on silica, that can react with HgS solids, thereby increasing the size of the submicron mercury with subsequent removal by filtration or other mechanical processes (centrifuge, settling). over A particular embodiment is reacting silica with immobilized thiol groups with HgS particles of all sizes to form large particles that can be removed with a coarse filter, preferably >20 micron filter. Monothiols of C18 or less may be added to convert the majority of mercury into dissolved mercury with the subsequent reaction addition of silica with immobilized thiol groups to the dissolved mercury allowing removal by coarse filters such as a 20 micron filter.

A further embodiment of the invention is a dissolving chemical is added to a high mercury feed and allowed to react with all sizes of HgS to form smaller or dissolved mercury. Chemicals to react with all sizes of HgS to form smaller or dissolved mercury include but are not limited to Thiols, Alkylthiols: C3-10 thiols, dithiols: toluene-X,X-dithiol, benzene-X,X-dithiol and alkyldithiol. Then solid/miscible liquid sulfur source is subsequently added to the said high mercury feed to react with mercury to form larger HgS particles. The formed larger HgS particles are then removed by sedimentation, centrifugation, or filtration. The solid/miscible liquid sulfur source can be added in line as a chemical additive or in a feed tank as a body feed/filter aid material. Alternatively, a solid sulfide source can be used as a precoat material of a filtering device prior to filtration. The product stream is reduced in mercury.

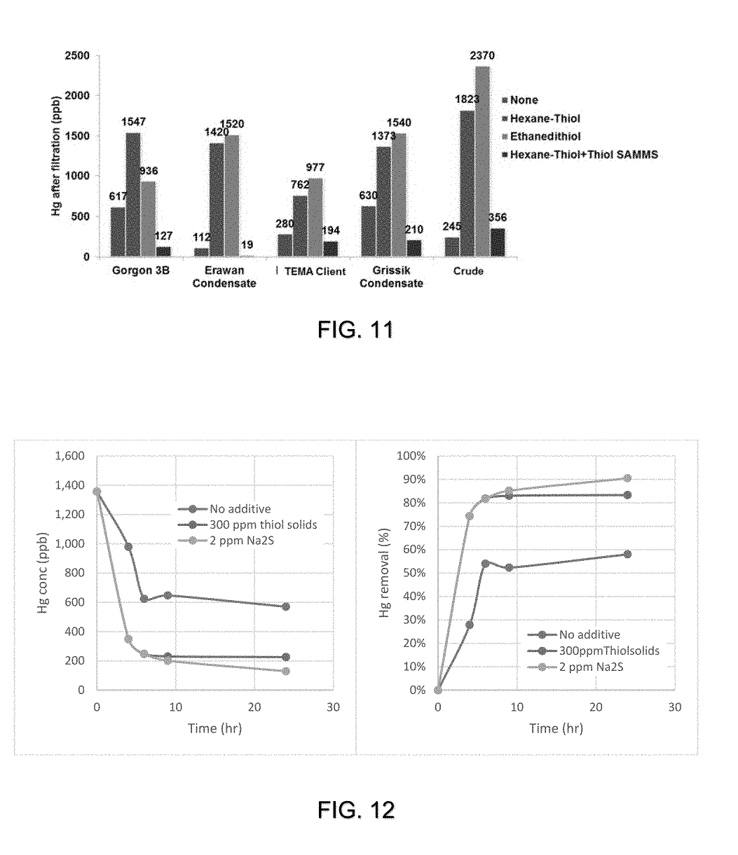

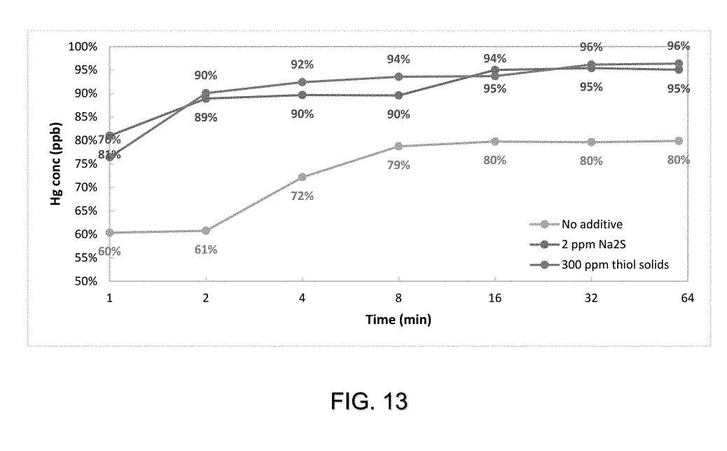

The addition of the sulfide source increases the sedimentation rate at least 3 times over processing conditions without the additional source demonstrating the increase in the size of mercury species (FIG. 11). Specifically, the addition of sulfide and thiol functionalized solids to condensate increased the removal and settling rate of mercury in sedimentation The addition of sulfide and thiol functionalized solids to G condensate increased the removal and settling velocity of mercury in centrifugation studies. In order to achieve 80% removal without additives, it takes 8 mins in a centrifuge at 360 applied g-force. This corresponds to a sedimentation velocity per g-force of 2.2 e-7 m/s. Additives can achieve 80% removal at 1 min in a centrifugate at 360 applied g-force. This corresponds to a sedimentation velocity per g-force of 1.7 e-6 m/s (FIG. 12). The centrifugation data, fluid and solids properties and the usage of the stokes law denote that the additive(s) increases the average mercury size 3 times.

When a high mercury feed is filtered through a filter or membrane, the filter or membrane material is functionalized with multiple sulfur groups such as thiol, thiourea, and other sulfide groups. Large mercury particulate is removed at the surface of the filter or membrane while dissolved (elemental, ionic), and all sizes of HgS are removed by adsorption or reaction with the filter/membrane material.

A further embodiment is an aqueous/immiscible liquid sulfide source is added to a high mercury feed (crude, condensate, water, or other liquid). A distinct reactor is not required to react with all sizes of HgS; however, a large reactor with a processing capacity of 30 min. to 2 hrs. may be required due to mass transfer limitations of the aqueous/immiscible liquid sulfide source into the feed. Then, the sulfide is allowed to react with elemental mercury, ionic mercury, and submicron HgS to form larger HgS particles of 0.5 microns or greater. The larger HgS particles are then removed by sedimentation, centrifugation, or filtration. The product stream is reduced in mercury content.

An additional embodiment is a solid/miscible liquid sulfide source is added to a high mercury feed, the sulfide is allowed to react with dissolved species of mercury including elemental mercury, ionic mercury and all sizes of HgS to form larger HgS particles (>10, >20 microns). The larger HgS particles are then removed by sedimentation, centrifugation, or filtration. The solid/miscible liquid sulfide source can be added in line as a chemical additive or in a feed tank as a body feed/filter aid material. Alternatively, a solid sulfide source can be used as a precoat material for filtration. The product stream is reduced in mercury.

Solid sulfide sources include but are not limited to Na2S powder; Silica functionalized with multiple sulfur groups such as thiourea, thiol or other sulfide groups; DE functionalized with multiple sulfur groups such as thiourea, thiol or other sulfide groups; cellulose functionalized with multiple sulfur groups such as thiourea, thiol or other sulfide groups; other solid substrates functionalized with multiple sulfur groups such as thiourea, thiol or other sulfide sources; Metal sulfides such as: Cu₂S, CuS, and commercially available mercury vapor sorbents (i.e. JM Puraspec P5158, Axens AxTrap 273, or UOP GB-346S).

Hydrocarbon miscible liquid sulfide sources include but are not limited to commercially available polymers such as NALMET™; other polymers containing multiple sulfur sources such as thiosulfate, sulfide, thiol, thiourea, carbon disulfide, and other sulfide groups; small molecules with multiple thiol groups.

For all embodiments, an optional desanding/coarse solids removal step may precede the process. This removal step would lower the total suspended solids and remove mercury associated with larger particles. This potentially will save on chemical consumption and filtration cost.

Alternatively, the filter or membrane is a composite material that contains immobilized solids that contain thiol, thiourea, or other sulfide groups. Large mercury particulate is removed at the surface of the filter or membrane while elemental, ionic, and all sizes of HgS are removed by adsorption or reaction with the filter/membrane material. Journal of Membrane Science 251 (2005) 169-178

### EXAMPLES

The following examples are given to illustrate the present invention. It should be understood, however, that the invention is not limited to the specific conditions or details described in these examples.

### 1) Condensate 1

This phenomenon was observed in work funded by ABU TD in 2015 to examine filtration for mercury removal from sample G condensates. Filtration alone (0.45 micron filter) reduces mercury from 1,300 ppb down to approximately 270-300 ppb. Addition of an aqueous solution of Na2S at concentrations of 400 ppb Na2S in the bulk condensate is able to reduce the mercury content below 100 ppb after filtration by a 0.45 micron filter.

Mercury particle size distribution was done before and after sulfide addition. It was determined that sulfide addition selective to particles <0.45 microns. The mercury particles susceptible to reaction with sulfide addition are believed to be in the nanoparticle size domain.

Separately, mercury speciation work examined the mercury concentration as a function of boiling point in different condensate samples. It was determined that elemental and low boiling point alkyl mercury species were not present. The results suggest that mercury bonded to sulfur species, as such HgS, could be the main specie at that temperature range (550-950° F.). However, it is possible that HgS decomposition at that boiling point range leading to Hg(0) and sulfur could be also operating. Further mechanism investigation is in progress.

Experiments examining multiple sulfide sources were conducted on condensate. After chemical addition and reaction, mercury removal by settling and filtration (0.45 micron) were conducted. Results show that Na2S, Nalmet, thiourea on silica, thiol SAMMS (Self-assembled monolayer on mesoporous silica), thiosulfate polymer, and JM adsorbent increased Hg removal by settling and filtering.

Thiol SAMMS in particular was successful in increasing the removal rate for both settling and filtration. Different concentrations of thiol SAMMS were examine to see the minimum dosage required to be effective. Settling studies show that a large amount is required to have an enhanced effect (10,000 ppm). Filtration studies show that a smaller amount is required to have an enhanced effect (<300 ppm). Studies on the effective concentrations of Nalmet, and thiourea on silica are planned for the future.

### 2) Condensate 2

Similar experiments were conducted with sample E condensate (2,400 ppb Hg) showing that certain additives can increase mercury removal. Filtration by 0.45 micron filter without sulfide addition removes mercury to 50 ppb. This is expected as it is known that sample E contains mostly large particles. Addition of Na2S in water reduces this slightly to 25 ppb. Addition of thiourea on silica and thiol SAMMS reduce mercury to 20 ppb and less than 1 ppb respectively.

Sulfide addition enhances mercury removal by settling for sample E condensate. After 1.5 hrs of settling without sulfide addition removes mercury to 2,000 ppb. Addition of Na2S has little effect. Addition of thiourea on silica, and Cu2S modestly increase removal to 790 ppb and 880 pbb respectively. Addition of thiol SAMMS greatly enhanced removal to 50 ppb.

Overnight settling without sulfide addition removes mercury to 700 ppb. Several additives enhance mercury removal. The large enhancement of removal is with thiourea on silica (<50 ppb), thiol SAMMS (<50 ppb), and hydrotalcite (<50 ppb).

Thiol SAMMS required loads of less than 300 ppm for enhanced removal by filtration (40 ppb Hg down to <1 ppb). Thiol SAMMS required high loads of 10,000 ppm for enhanced removal by sedimentation. In similar experiments show that hydrotalcite also requires high loading (10,000 ppm) for enhanced removal by sedimentation.

### 3) Crude

Similar experiments were conducted with a CVX crude (9,000 ppb Hg) showing that thiol SAMMS can increase mercury removal. Filtration by 0.45-micron filter without sulfide addition removes mercury to 270 ppb. Addition of Na2S in water had no additional removal. Addition of thiol SAMMS reduce mercury to 50 ppb.

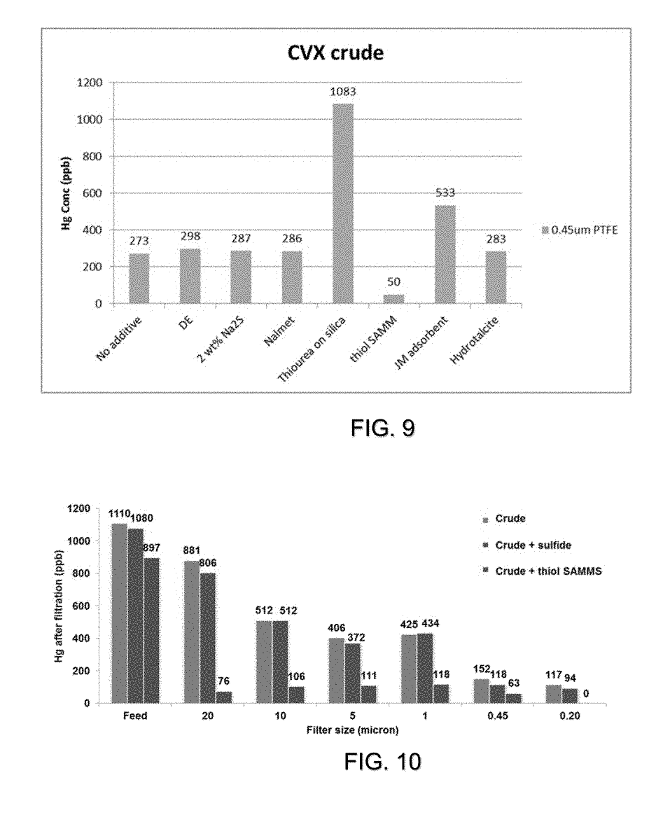

FIG. 9 shows the enhanced ability of a coarse filter to remove mercury after thiol SAMMS addition. Filtration of CVX crude with thiol SAMMS addition with various size filters was conducted. The data shows that the addition of thiol SAMMS allows for enhanced removal at a large filter size. This suggest that addition of thiol SAMMS enhances the removal of dissolved and particulate mercury through coarser (>20 micron vs 0.45 micron) filtration.

FIG. 10 shows the ability of mono or dithiols followed by thiol SAMMS addition to increase the removal of mercury. It shows that mono and dithiols can convert HgS into a dissolved mercury species. The mercury species dissolved by the mono or dithiol can then be reacted with thiol SAMMS to form large particulate that then can be removed by mechanical separation (filtration, centrifugation, sedimentation).

1. A process for the removal of mercury comprising reacting a sulfide source with submicron mercury solids to increase the size and sedimentation rate of the submicron mercury and subsequently removing the mercury.

2. The process of claim 1 wherein the increase in sedimentation rate is further assisted by centrifugation.

3. The process of claim 2 wherein the sulfide source is selected from the group consisting of Na2S, liquid sulfide polymers, sulfur immobilized on silica.

4. The process of claim 3 wherein the mercury is selected from the group consisting of elemental, ionic or HgS.

5. The process of claim 4 wherein the mercury is HgS.

6. The process of claim 5 wherein the size is increased to 20 microns or greater.

7. The process of claim 6 wherein the size is increased from 10 microns to 20 microns.

8. The process of claim 7 wherein the mercury is removed by filtration.
